(19) United States
(12) Patent Application Publication
(10) Pub. No.: US 2017/0307240 A1
(43) Pub. Date: Oct. 26, 2017

(54) Remote Reset Device

(71) Applicant: RVA Lighting & Masts Inc., Toronto (CA)

(72) Inventor: James Fess, Toronto (CA)

(21) Appl. No.: 15/497,540

(22) Filed: Apr. 26, 2017

Related U.S. Application Data
(60) Provisional application No. 62/327,530, filed on Apr. 26, 2016.

(51) Int. Cl. F24F 11/00; H04B 7/155; G08C 17/02; G05B 15/02; H04W 88/08

(52) U.S. Cl. CPC F24F 11/006; G08C 17/02; G05B 15/02; H04B 7/155; F24F 2011/0061; G05B 2219/2614; H04W 88/08

(57) ABSTRACT

The device is for use with a wireless transmitter and a cell site. The cell site is of the type that includes a base station, the base station having an HVAC system. The device includes: a relay adapted to be coupled to the HVAC system, adapted to be triggered and adapted, when coupled to the HVAC system and triggered, to reset the HVAC system; a receiver adapted for communication with the transmitter; and a computing facility coupled to the receiver and the relay, the computing facility being adapted to trigger the relay responsive to the receiver.

### RELATED APPLICATION DATA

This application claims the benefit of priority of U.S. Provisional Patent Application Ser. No. 62/327,530, filed Apr. 26, 2016, and titled “Remote Reset Device”, which is incorporated by reference herein in its entirety.

### FIELD OF THE INVENTION

The present invention generally relates to the field of transmission towers. In particular, the present invention is directed to a remote resent device.

### BACKGROUND

In order to provide cellular telephone coverage in remote locations, it is often necessary to place transmission towers in remote locations. Typically, small structures are situated nearby the towers, in which expensive electronic equipment and batteries are secured. The structures are commonly climate-controlled, as, inter alia, the contents deteriorate or fail at elevated temperatures. It is known, as a result of, inter alia, soiling, for the HVAC equipment to enter a high pressure lockout state. When this occurs, it is commonplace for the tower operator to dispatch a technician to service the equipment. Technicians are known to arrive too late to avoid damage to the batteries and equipment, and to arrive too late to avoid radio failure.

### SUMMARY OF THE DISCLOSURE

Forming one aspect of the invention is apparatus for use with: a wireless transmitter; and a cell site, the cell site being of the type that includes a base station, the base station having an HVAC system. This apparatus comprises: a relay adapted to be coupled to the HVAC system, adapted to be triggered and adapted, when coupled to the HVAC system and triggered, to reset the HVAC system; a receiver adapted for communication with the transmitter; and a computing facility coupled to the receiver and the relay, the computing facility being adapted to trigger the relay responsive to the receiver.

According to another aspect, the receiver can be a cellular receiver.

An improved cell site forms another aspect of the invention. The cell site is of the type that includes a base station, the base station having an HVAC system. The improvement comprises: a relay coupled to the HVAC system, adapted to be triggered and adapted, when triggered, to reset the HVAC system; a receiver; and a computing facility coupled to the receiver and the relay, the computing facility being adapted to trigger the relay responsive to the receiver.

According to another aspect, the receiver can be a wireless receiver.

According to another aspect, the receiver can be a cellular receiver.

Advantages, features and characteristics of the invention will become evident upon review of the following detailed description, with reference to the appended drawing, the latter being briefly described hereinafter.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a schematic view of an exemplary embodiment of the invention in use with a cell site.

### DETAILED DESCRIPTION

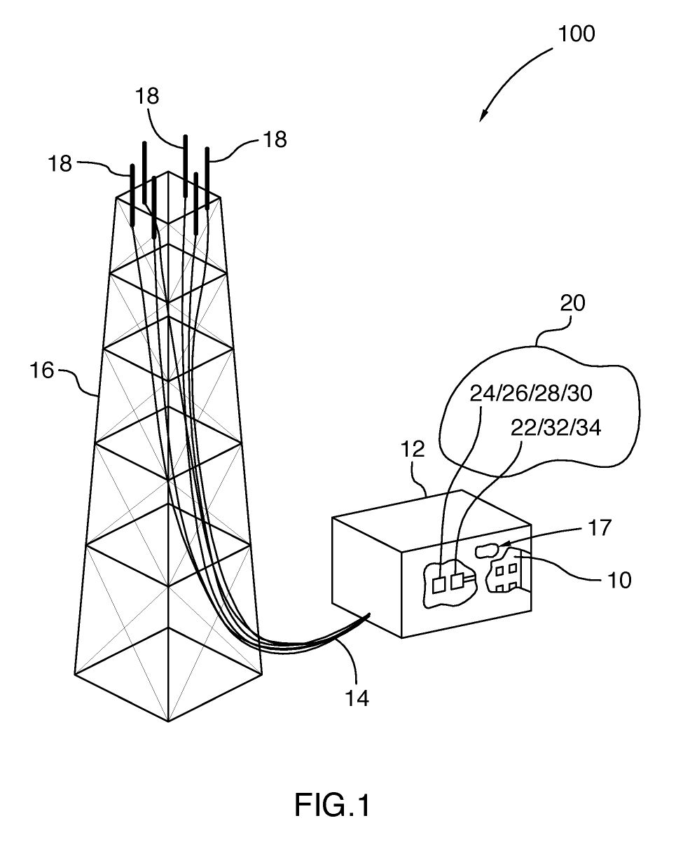

In FIG. 1, the exemplary embodiment of the invention is indicated with general reference numeral 20 and the cell site is designated with general reference numeral 100.

The cell site 100, which will be understood to form part of a cellular telephone system, not shown, is generally conventional and will be seen to include a group of antennas 18 connected to base station electronics 10. The electronics 10 communicate with a centralized mobile telephone switching office at another location (neither shown), which in turn communicates with the public switched telephone network (not shown). The base station electronics 10 are housed in a weatherproof shelter 12 (shown in a partially cut-away view to illustrate electronics 10 inside). Cables 14 extending between enclosure 12 and the antenna tower 16 carry signals between electronics 10 and the antennas 18. A high temperature alarm functionality, indicated as 17, is adapted to send a notification to the tower operator in the event that the shelter temperature is above 70 F.

The exemplary apparatus 20 comprises a relay 22, a computer 24, a transceiver 26, a temperature sensor 28, a humidity sensor 30, a current sensor 32 and a voltage sensor 34.

The relay is 22 is coupled to the HVAC system and is adapted to, when triggered, reset the HVAC system.

The computing device 24 and transceiver 26 may comprise, in one embodiment, a remotely-IP addressable minicomputer, such as a Rasberry Pi 2 designed by the Rasberry Pi Foundation and available through distributors such as Adafruit, www.adafruit.com, and is coupled to the relay 22 to selectively trigger the relay 22.

The temperature sensor 28 is adapted to sense temperature.

The humidity sensor 30 is adapted to sense humidity.

The current sensor 32 is coupled in the compressor circuit, to sense current draw by the compressor.

The voltage sensor 34 is coupled to the line voltage for the HVAC system.

An exemplary use of the apparatus is as follows:
the high Temp Alarm functionality 17 signals a problem to the tower operator;
the operator logs in to the computer 24 via a server, it being understood that computer 24, e.g., the Raspberry-pi 2, is a remotably-IP-addressable box, and observes live temperature, humidity, voltage and current readings to HVAC unit;
after verifying that the internal temperature is elevated, current draw is low and voltage is correct, the operator uses the reset feature to reset the HVAC unit completely for 30 seconds;
if the current draw increases to normal levels, this indicates that the HVAC compressor has restarted; if current draw remains minimal, then a technician is dispatched immediately; and
if, 10 minutes after reset, ambient temperature shows a decrease, then maintenance for the system can be scheduled as convenient; if ambient temperature is not decreasing, then a technician is dispatched immediately.

Persons of ordinary skill will readily appreciate the surprising advantage associated with the ability to remotely reset the HVAC system:
routine maintenance periods can be lengthened; and
emergency technicians can service more towers within a given geographic area.

Whereas a single embodiment is described, variations are possible. For example, whereas a Raspberry Pi 2 is mentioned, other computing functionalities can be used. As well, whereas the exemplary device includes dedicated temperature, humidity, current and voltage sensors, this is not necessary, and sensors associated with the cell site could be deployed. Further, whereas the exemplary device is a remotely IP addressable system accessible via a cellular network, this is not strictly necessary; aspects of the functionality could, for example, be borrowed from the site. For example, the last line to the device could be defined by Wi-Fi, BlueTooth, telephony, satellite, etc. Further, whereas the description specifically mentions cell sites, the invention can be deployed with usefulness in any context wherein temperature-sensitive electronics are housed in a remote, HVAC-controlled structure. Accordingly, the detailed description should be understood to be non-limiting.

The foregoing has been a detailed description of illustrative embodiments of the invention. It is noted that in the present specification and claims appended hereto, conjunctive language such as is used in the phrases “at least one of X, Y and Z” and “one or more of X, Y, and Z,” unless specifically stated or indicated otherwise, shall be taken to mean that each item in the conjunctive list can be present in any number exclusive of every other item in the list or in any number in combination with any or all other item(s) in the conjunctive list, each of which may also be present in any number. Applying this general rule, the conjunctive phrases in the foregoing examples in which the conjunctive list consists of X, Y, and Z shall each encompass: one or more of X; one or more of Y; one or more of Z; one or more of X and one or more of Y; one or more of Y and one or more of Z; one or more of X and one or more of Z; and one or more of X, one or more of Y and one or more of Z.

Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. Apparatus for use with a wireless transmitter and a cell site, the cell site being of the type that includes a base station, the base station having an HVAC system, the apparatus comprising:
a relay adapted to be coupled to the HVAC system, adapted to be triggered and adapted, when coupled to the HVAC system and triggered, to reset the HVAC system;
a receiver adapted for communication with the transmitter; and
a computing facility coupled to the receiver and the relay, the computing facility being adapted to trigger the relay responsive to the receiver.

2. Apparatus according to claim 1, wherein the receiver is a cellular receiver.

3. An improved cell site of the type that includes a base station, the base station having an HVAC system, the improvement comprising:
a relay coupled to the HVAC system, adapted to be triggered and adapted, when triggered, to reset the HVAC system;
a receiver; and
a computing facility coupled to the receiver and the relay, the computing facility being adapted to trigger the relay responsive to the receiver.

4. An improved cell site according to claim 3, wherein the receiver is a wireless receiver.

5. An improved cell site according to claim 3, wherein the receiver is a cellular receiver.
